(19) United States
(12) Patent Application Publication
(10) Pub. No.: US 2009/0015129 A1
(43) Pub. Date: Jan. 15, 2009

(54) Method and device for a compact fluorescent bulb

(76) Inventors: Noam Arye, Ashdod (IL); Naftaly Moskowitz, Ashdod (IL)

Correspondence Address: UZI EZRA HAVOSHA & PARTNERS, HADAR-DAFNA HOUSE 39 SHAOUL HAMELECH STREET, TEL AVIV, 64928, IL

(21) Appl. No.: 11/827,403

(22) Filed: Jul. 12, 2007

(51) Int. Cl. H01J 61/42

(52) U.S. Cl. 313/485

(57) ABSTRACT

Fluorescent bulb with inner tubes of inert gas and phosphor coating on the inner surface of an outer bulb that encompasses the inner tubes. The increased efficiency of such light bulbs enables the same strength light emission in a smaller size bulb.

### FIELD OF THE INVENTION

This invention is in the field of electric bulbs and in particular fluorescent bulbs commonly known as PL and EL bulbs.

### BACKGROUND OF THE INVENTION

Fluorescent bulbs in the lighting industry are well known in the art. In recent years attempts have been made to reduce the long tubular bulbs to smaller versions that fit light fittings made for incandescent bulbs. While this has been achieved to some extent, the efficiency of these smaller kind of fluorescent bulbs is reduced. The main reason for this reduction in efficiency is based on the principle that the amount of light emitted is proportional to the visible surface area of phosphor coated glass. A key word in the latter sentence is “visible” as coated glass that is not visible or whose emitted light is not visible because of obstruction does not increase the visible light.

Fluorescent bulbs work by having a gas, for example, Neon which is excited by an electrical charge which causes the fluorescent coating on the internal side of the glass bulb to glow. The greater the surface area of glass with fluorescent coating the brighter the glow will be. The usual way of making PL bulbs is to make them from a few narrow tubes of glass or a spiral of narrow tubes to maximise the surface area of glass. The main disadvantage of these narrow glass tubes is that about half their surface area faces towards the inside that is to say, towards the inside portion of other glass tubes. These inside facing parts of tubing light up with the rest of the bulb and are wasted for lighting purposes because their light is not visible; it is trapped inside. The strength of light is proportional to the surface area of coated glass that faces the places that need to be lit. So approximately half of the light emitted faces the inner portion of the spiral or upright tubes. This state of art compact bulb reveals an inefficient method of lighting. A large portion of light produced is not seen. Only the light emitted from the phosphor coated glass facing the outside of the bulb produces the required quantity of light.

PL and EL are types of compact fluorescent bulbs. The main difference between these two types of bulb is the method of starting. All fluorescent bulbs need a high voltage to start the lighting process and thereafter the voltage is reduced. Starters or chokes or electronic cards do this job of creating the high voltage for starting.

This invention reveals a device that increases the surface area of glass that have phosphor coated on them and therefore increase the amount of light radiating from the bulb. Expressed another way, this invention reveals a device that enables the same strength of emitted visible light in a smaller device than possible at present. A practical result of this invention is that the compact fluorescent bulb will have a wider application in the lighting market as applications requiring a smaller size are not possible with today's known technology.

### SUMMARY OF THE INVENTION

It is to be understood that both the foregoing general description and the following detailed description present embodiments of the invention and are intended to provide an overview or framework for understanding the nature and character of the invention as it is claimed. The accompanying drawings are included to provide a further understanding of the invention and are incorporated into and constitute a part of this specification. The drawings illustrate various embodiments of the invention and, together with the description, serve to explain the principles and operations of the invention but the not to limit the invention to these descriptions only.

This invention comprises a compact light bulb that has inner tubes filled with a gas like Argon as is practiced in industry today. The difference is that there is no phosphor coating on the surface of the inner tubes. Instead the phosphor coating is made on the inner surface of an outer glass bulb that encompasses the inner gas filled tubes. The gas is excited by the flow of electricity in the same way as in state of the art compact PL and EL type bulbs. Similarly, the gas emits ultra-violet light as in state of art bulbs. The difference is that the ultra-violet light does not hit the phosphor on the inner tubes because the inner tubes are plain glass. The phosphor coating is on the bulb that encompasses the inner tubes. This greatly increases the area of visible phosphor coated glass that glows when hit by the ultra-violet light from the excited gas in the inner tubes. The greater this area of phosphor that is facing externally from the bulb, the greater the amount of light visible per watt of electricity used.

This greater efficiency can be reflected in more light being emitted from the same sized bulb or by enabling the same amount of light being emitted from a smaller sized bulb. Especially this latter result of this invention will greatly increase the commercial applications of the compact fluorescent bulb.

### BRIEF DESCRIPTION OF THE DRAWINGS

The accompanying drawings, which are incorporated in and form a part of this specification, illustrate embodiments of the invention and together with the description, serve to explain by way of example only, the principles of the invention:

FIG. 1 is a schematic depiction of a state of the art compact fluorescent light bulb.

FIG. 2 is a schematic depiction of another kind of state of the art compact fluorescent light bulb.

FIG. 3 is a plan view of a compact fluorescent light bulb.

FIG. 4 is a schematic depiction of a compact fluorescent light bulb of this invention.

FIG. 5 is a plan view of a compact fluorescent light bulb of this invention.

FIG. 6 is a schematic depiction of a compact fluorescent light bulb of this invention in a spot-light type of bulb.

### DETAILED DESCRIPTION OF THE PREFERRED EMBODIMENTS

As will be appreciated the present invention is capable of other and different embodiments than those discussed above and described in more detail below, and its several details are capable of modifications in various aspects, all without departing from the spirit of the invention. Accordingly, the drawings and description of the embodiments set forth below are to be regarded as illustrative in nature and not restrictive.

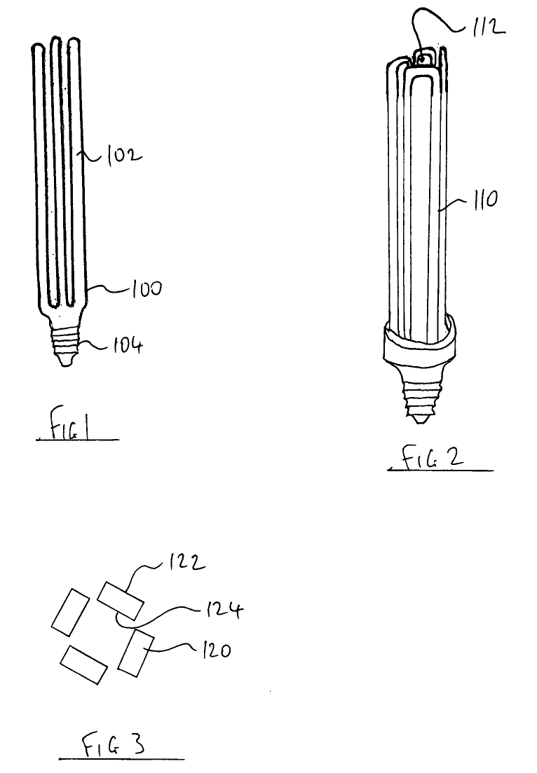

FIG. 1 shows a compact light bulb 100. The narrow gas filled tubes 102 are coated on the inner surface of the tubes 102 with phosphor. The screw thread 104 is made to fit the standard light socket fitting.

FIG. 2 is a similar compact light bulb to that in FIG. 1 with a different configuration of glass tubes 110. The glass tubes are like arches in an attempt to increase the surface area of visible tube. However the tubes are still in a circular or square formation and a large percentage of phosphor coated glass faces the internal portion 112 of the circle or square. The light emitted in this internal portion 112 is wasted energy as it is not visible to the onlooker.

FIG. 3 is a plan view of the state of art compact light bulb. The gas filled phosphor coated tubes 120 form a square shape. The outer facing portion of the tubes 122 cause the visible light that benefits the onlooker. The inner facing portion of the tubes 124 does not benefit the onlookers.

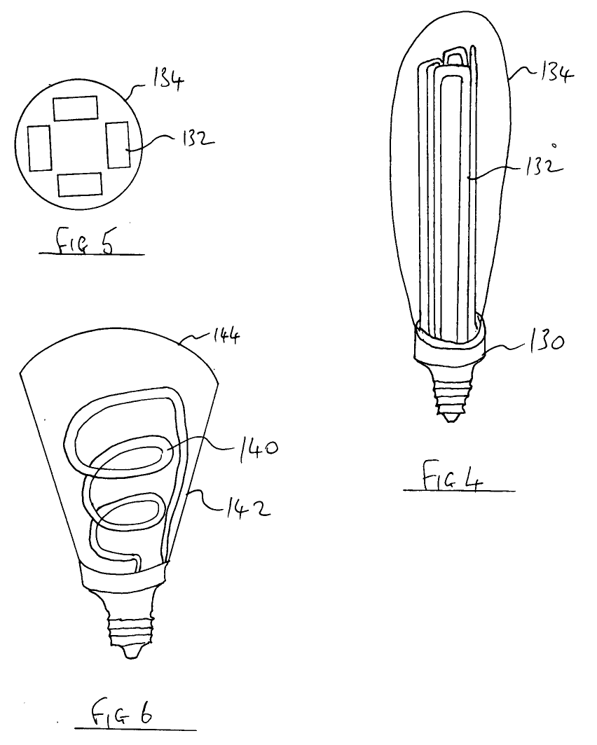

FIG. 4 shows an example of the compact light bulb 130 of this invention. The glass tubes 132 can be in the same formation as the state of art bulbs and the tubes can be filled with the same gas. The main difference is that the tubes 132 are plain glass without any coating of phosphor. The tubes 132 are encompassed by a glass bulb 134 which is coated on its inside surface with phosphor.

FIG. 5 is the plan view of the bulb of FIG. 4 showing the tubes 132 and the surrounding glass bulb 134.

FIG. 6 shows a compact light bulb with a spiral inner tubing 140. The spiral formation is an alternate configuration to the upright inner tubes. This bulb is referred to as a spot light as it concentrates and focuses its light to a focused area by means of reflecting surface 142. The glass surface out of which the light is emitted 144 is coated on its inner surface with phosphor.

What is claimed:

1. A method and device for a compact fluorescent light bulb comprising,
a. gas filled glass tubes,
b. a glass bulb encompassing the said glass tubes,
c. a coating of phosphor on the inside surface of the 10 said glass bulb,
d. a means to start the process of exciting the gas atoms that cause the phosphor to fluoresce.
e. a means of attachment to an electric light socket, whereby the said coated glass bulb will emit light when an electric current is applied.

2. A method and device for a compact fluorescent light bulb as claimed in claim 1 wherein the said gas filled tubes are arch shaped.

3. A method and device for a compact fluorescent light bulb as claimed in claim 1 wherein the said gas filled tubes are spiral shaped.

4. A method and device for a compact fluorescent light bulb as claimed in claim 1 wherein the said gas filled tubes are cylindrical shaped.

5. A method and device for a compact fluorescent light bulb as claimed in claim 1 wherein the gas in the said gas filled tubes is neon.

6. A method and device for a compact fluorescent light bulb as claimed in claim 1 wherein the gas in the said gas filled tubes is an inert gas.

7. A method and device for a compact fluorescent light bulb as claimed in claim 1 wherein the gas in the said gas filled tubes is contains mercury vapor.
